(19) United States
(12) Patent Application Publication
(10) Pub. No.: US 2019/0250638 A1
(43) Pub. Date: Aug. 15, 2019

(54) Vehicle Fleet Control Device

(71) Applicant: MAGNA STEYR Fahrzeugtechnik AG & Co KG, Graz (AT)

(72) Inventors: Helfried MUELLER, Dobl (AT); Markus PASSATH, Gleisdorf (AT)

(21) Appl. No.: 16/271,973

(22) Filed: Feb. 11, 2019

(30) Foreign Application Priority Data
Feb. 13, 2018 (EP) 18156525.0

(51) Int. Cl. G05D 1/02; G06Q 20/04

(52) U.S. Cl. CPC G05D 1/0291; G05D 2201/0213; G05D 1/0212; G06Q 20/045

(57) ABSTRACT

A vehicle fleet control system having a vehicle fleet having at least two autonomous vehicles, and a control unit configured to control the autonomous vehicles. The control unit is configured to assign a priority status to each autonomous vehicle in the fleet, and calculate a travel route for each autonomous vehicle in the fleet on a basis of the assigned priority status. For autonomous vehicles having a same point of departure and a same point of destination, the control unit is configured to control the autonomous vehicle in the fleet having a greatest priority status down a calculated route that facilitates reaching a point of destination more rapidly than other autonomous vehicles in the fleet.

### CROSS-REFERENCE TO RELATED APPLICATIONS

The present application claims priority under 35 U.S.C. § 119 to European Patent Publication No. EP 18156525.0 (filed on Feb. 13, 2018), which is hereby incorporated by reference in its complete entirety.

### TECHNICAL FIELD

Embodiments relate to a vehicle fleet control system comprising a plurality of autonomous vehicles and a central control unit to control the autonomous vehicles and calculate a travel route therefor on a basis of an assigned priority status.

### BACKGROUND

Autonomous vehicles are known, and permit a predetermined destination to be reached “autonomously,” i.e., via a control unit which ascertains a suitable travel route for the vehicle in a sufficient degree of detail. This travel route can also be put into effect by the control unit and/or by an assigned secondary control unit, so that the intervention of a person as driver of the vehicle is not necessary.

A control unit may also have been designed as a “central station,” so that several autonomous vehicles can be controlled by one control unit, at least inasmuch as the travel routes of the several autonomous vehicles can be calculated in the degree of detail required for such vehicles. Several such vehicles may, in particular, constitute a vehicle fleet.

Traffic jams often form, particularly in towns, so that more time has to be spent in vehicles than would be necessary for the purpose of completing the journey as such. Depending upon circumstances, delays of such a type may be undesirable for certain vehicles or vehicle occupants.

### SUMMARY

Embodiments relate to enhanced autonomous vehicles and the control thereof.

Embodiments relate to a vehicle-fleet control system that better meets the differing needs for rapid reaching of the destination in autonomous vehicles.

In accordance with embodiments, a vehicle-fleet control system comprises: a vehicle fleet that includes a plurality of autonomous vehicles; and a central control unit to assign a priority status to each autonomous vehicle in the fleet, the control unit to calculate travel routes of each autonomous vehicle on a basis of the priority status upon receipt of a request for the calculation of a travel route for each autonomous vehicle in the fleet, from a defined point of departure to a defined point of destination, wherein, for autonomous vehicles in the fleet having a same point of departure and a same point of destination, the autonomous vehicle in the fleet having a higher assigned priority status is to reach the point of destination more rapidly than other autonomous vehicles in the fleet.

In accordance with embodiments, a vehicle-fleet control system comprises: a vehicle fleet that includes a first autonomous vehicle and a second autonomous vehicle; and a central control unit to assign a first priority status to the first autonomous vehicle and a second priority status the second autonomous vehicle, the control unit to calculate travel routes of the first autonomous vehicle and the second autonomous vehicle on a basis of the priority status upon receipt of a request for the calculation of a travel route for the first autonomous vehicle and the second autonomous vehicle, from a defined point of departure to a defined point of destination such that, when the first autonomous vehicle and the second autonomous vehicle have a same point of departure and a same point of destination, the first autonomous vehicle, by having a higher assigned priority status, is to reach the point of destination more rapidly than the second autonomous vehicles.

In accordance with embodiments, a vehicle fleet control system comprises several autonomous vehicles and a central control unit for calculating the travel routes of the autonomous vehicles. The autonomous vehicles may comprise, for example, at least one first autonomous vehicle and one second autonomous vehicle, a first priority status having been assigned in the control unit to the first autonomous vehicle, and a second priority status having been assigned in the control unit to the second autonomous vehicle. The control unit has been configured to calculate various travel routes on the basis of the differing priority statuses upon request for the calculation of a travel route for the first autonomous vehicle from a defined point of departure to a defined point of destination and upon request for the calculation of a travel route for the second autonomous vehicle from the same defined point of departure to the same defined point of destination, so that the first autonomous vehicle reaches the point of destination more rapidly than the second autonomous vehicle.

In accordance with embodiments, the behaviors of the vehicles in a fleet, to be operated by a central control unit, are coordinated with one another by the central control unit, so that vehicles in the fleet get to their destination more rapidly or less rapidly, depending on their respective assigned priority status. For this purpose, a different travel route is determined, and where appropriate, also put into effect, by the central control unit for vehicles in the fleet having first/higher priority from that for vehicles in the fleet having a second/lower priority.

In accordance with embodiments, the respective priority status may be allocated or assigned on the basis of a greater or lesser need of the vehicle. Alternatively or additionally, the respective priority status may be allocated or assigned on the basis of a desire by respective vehicle occupants to reach a destination rapidly. Alternatively or additionally, a higher priority or a lower priority may correspond to (i.e., be established by) monetary payment of a higher amount or lower amount to the operator of the vehicle-fleet control system. For example, the higher priority or lower priority may be assigned in accordance with a purchase of licenses of differing value, for instance, a “gold license,” a “silver license,” a “bronze license,” etc.

In accordance with embodiments, a first priority status may be assigned in/by the central control unit to a first autonomous vehicle on the basis of a first financial transaction, and a second priority status may be assigned in/by the central control unit to a second autonomous vehicle on the basis of a second financial transaction. The vehicle in the fleet that conducted the first financial transaction worth a first monetary value may be assigned a higher priority from other vehicles in the fleet that conducted the second financial transaction worth a second monetary value, when the first monetary value is greater than the second monetary value.

In accordance with embodiments, the first financial transaction and the second financial transaction may each represent the purchase of a temporally limited service. For example, the first financial transaction and the second financial transaction may each represent the purchase of an hourly, daily, weekly, monthly, or annual ticket. In this example, the first financial transaction may be at a first price that is greater than the second financial transaction at a second price.

In accordance with embodiments, alternatively or additionally, the central control unit may be configured to assign a shorter travel path, at least in some sections, to a first autonomous vehicle having a first priority status than to a second autonomous vehicle having a second priority status. The shorter path may comprise, for example, a shorter road or shorter lane. The shorter travel path may therefore relate to a longer distance, such as in the selection of a shorter connecting road, or to a shorter distance, such as in the selection of a lane or line of travel shortening the distance.

In accordance with embodiments, alternatively or additionally, the central control unit may be configured to assign a travel path that is designated for faster travel, at least in some sections, to a first autonomous vehicle having a first priority status than that assigned to a second autonomous vehicle having a second priority status. The faster travel path may comprise, for example, a faster road or a faster lane. The “design” for faster travel may have been granted by a natural or technical condition of the road, for instance, a better or wider road or road surface, or may also have been created by cultural requirements by establishment of a lane as an overtaking lane and such like.

In accordance with embodiments, alternatively or additionally, the control unit may be configured to assign a higher speed, to assign an overtaking lane, or to assign a superordinate rank at a junction, at least in some sections, to a first autonomous vehicle having a first priority status, and/or to assign a lower speed or a stop, to assign a slower lane (i.e., an already congested lane), or to assign a subordinate rank at a junction, at least in some sections, to a second autonomous vehicle having a second priority status.

Embodiments may also include a method for controlling a vehicle fleet comprising two or more autonomous vehicles.

### DRAWINGS

Embodiments will be illustrated by way of example in the drawings and explained in the description below.

FIG. 1 illustrates a schematic diagram of a vehicle fleet control system, in accordance with embodiments.

FIG. 2 illustrates a schematic diagram of a travel route protocol for the vehicle fleet control system of FIG. 1.

FIG. 3 illustrates a schematic diagram of a priority status protocol for the vehicle fleet control system of FIG. 1.

### DESCRIPTION

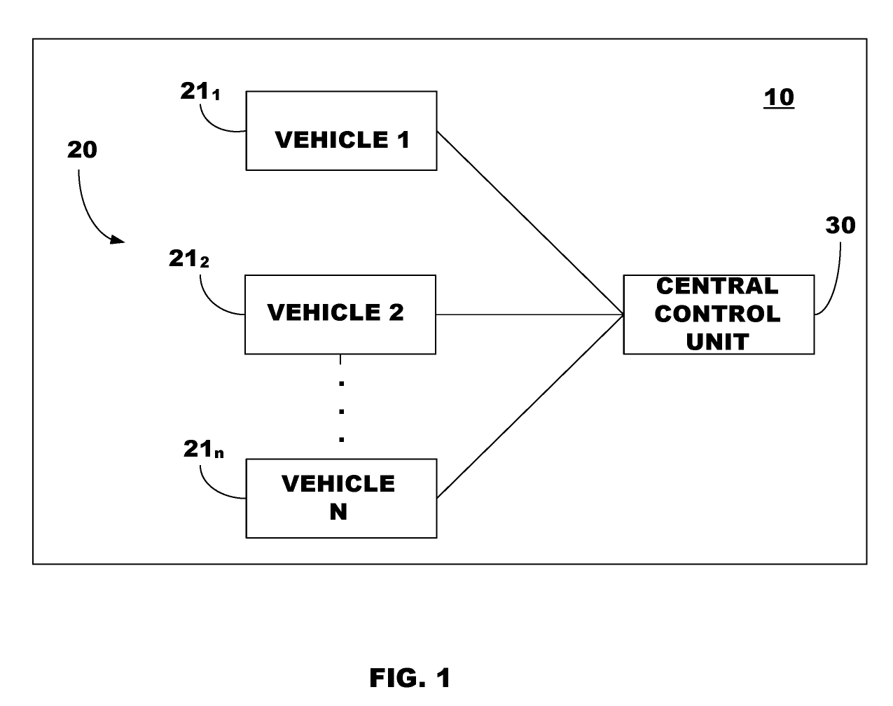

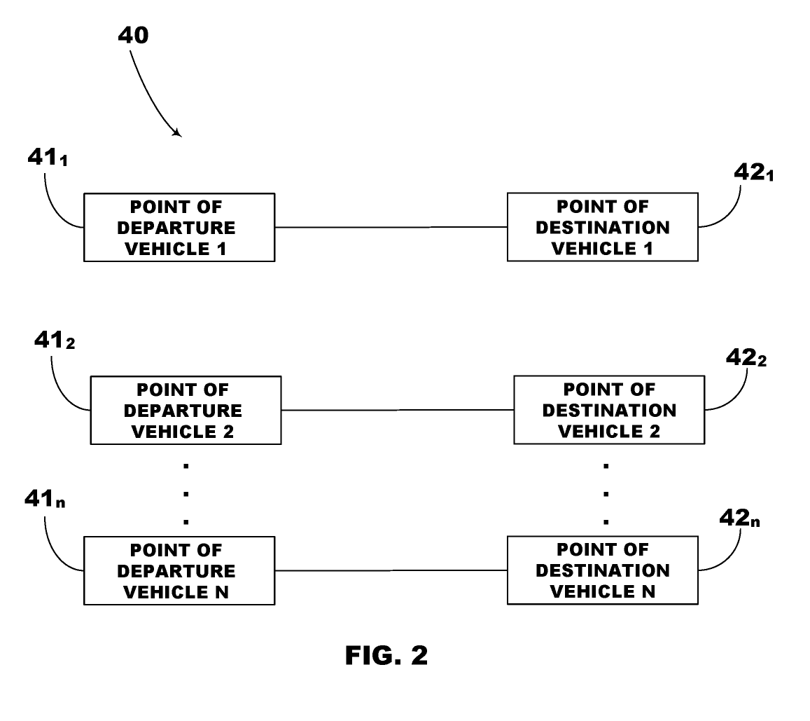

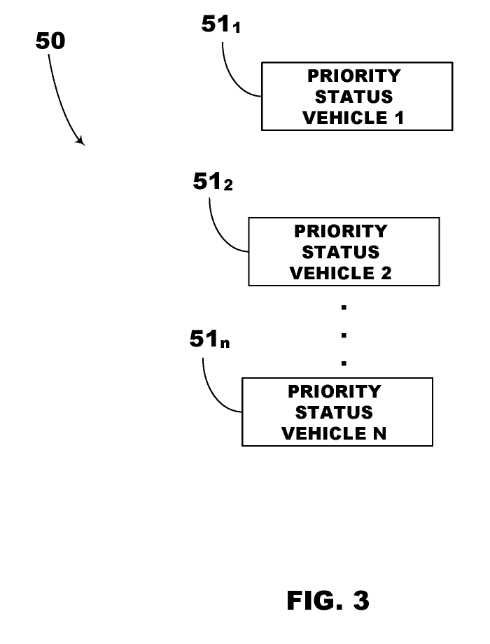

As illustrated in FIGS. 1 through 3, a vehicle fleet control system 10 may comprise, for example, a vehicle fleet 20 having at least two autonomous vehicles, including a first autonomous vehicle 21₁ and a second autonomous vehicle 21₂. The vehicle fleet 20 may include a plurality of autonomous vehicles 21₁, 21₂, . . . 21ₙ.

A central control unit 30 operatively connected to each autonomous vehicle 21₁, 21₂, . . . 21ₙ in the fleet 20, and configured to control operation thereof. For example, the central control unit 30 may be configured to implement a priority system 50 in order to assign a priority status 51₁, 51₂, . . . 51ₙ to each autonomous vehicle 21₁, 21₂, . . . 21ₙ in the fleet 20. The central control unit 30 may be configured to calculate travel routes 40 of each autonomous vehicle 21₁, 21₂, . . . 21ₙ on a basis of the priority status 51₁, 51₂, . . . 51ₙ upon receipt of a request for the calculation of a travel route 40 for each autonomous vehicle 21₁, 21₂, . . . 21ₙ in the fleet 20, from a defined point of departure 41₁, 41₂, . . . 41ₙ to a defined point of destination 42₁, 42₂, . . . 42ₙ. For autonomous vehicles 21₁, 21₂, . . . 21ₙ in the fleet 20 having a same point of departure 41₁, 41₂, . . . 41ₙ and a same point of destination 42₁, 42₂, . . . 42ₙ, the autonomous vehicle 21₁, 21₂, . . . 21ₙ in the fleet 20 having a highest assigned priority status 51₁, 51₂, . . . 51ₙ is to reach the point of destination 42₁, 42₂, . . . 42ₙ more rapidly than other autonomous vehicles 21₁, 21₂, . . . 21ₙ in the fleet 20 having a lower assigned priority status 51₁, 51₂, . . . 51ₙ.

In accordance with embodiments, the control unit is configured to calculate various travel routes 40 on the basis of the differing priority statuses 51₁, 51₂, . . . 51ₙ upon request for the calculation of a travel route 40 for autonomous vehicles 21₁, 21₂, . . . 21ₙ in the fleet 20. In that way, the behaviors of the autonomous vehicles 21₁, 21₂, . . . 21ₙ in the fleet 20, to be operated by the central control unit 30, are coordinated with one another by the central control unit 30. Meaning, autonomous vehicles 21₁, 21₂, . . . 21ₙ in the fleet 20 get to arrive at a respective destination 42₁, 42₂, . . . 42ₙ more rapidly or less rapidly, depending on the respective assigned priority status 51₁, 51₂, . . . 51ₙ.

In accordance with embodiments, priority status 51₁, 51₂, . . . 51ₙ may be allocated or assigned by the central control unit 30 on the basis of a greater or lesser need of the autonomous vehicle 21₁, 21₂, . . . 21ₙ. Alternatively or additionally, the respective priority status 51₁, 51₂, . . . 51ₙ may be allocated or assigned by the central control unit 30 on the basis of a desire by occupants of each respective autonomous vehicle 21₁, 21₂, . . . 21ₙ to reach a destination rapidly. Alternatively or additionally, a high priority status or a low priority status may correspond to (i.e., be established by) monetary payment of a higher amount or lower amount to the operator of the vehicle-fleet control system 10. For example, the higher priority or lower priority may be assigned in accordance with a purchase of licenses of differing value, for instance, a “gold license,” a “silver license,” a “bronze license,” etc.

In accordance with embodiments, a first priority status 51₁ may be assigned in/by the central control unit 20 to a first autonomous vehicle 21₁ in the fleet 20 on the basis of a first financial transaction X, and a second priority status 51₂ may be assigned in/by the central control unit 20 to a second autonomous vehicle 21₂ in the fleet 20 on the basis of a second financial transaction Y. The first autonomous vehicle 21₁ in the fleet 20 that conducted the first financial transaction X worth a certain monetary value may be assigned a higher priority from the second autonomous vehicle 21₂ in the fleet 20 that conducted the second financial transaction Y should the monetary value of the first financial transaction X be greater than the monetary value of the second financial transaction Y.

In accordance with embodiments, the first financial transaction X and the second financial transaction may each represent the purchase of a temporally limited service. For example, the first financial transaction X and the second financial transaction Y may each represent the purchase of an hourly, daily, weekly, monthly, or annual ticket. In this example, the first financial transaction X may be at a first price that is greater than the second financial transaction Y at a second price.

In accordance with embodiments, alternatively or additionally, the central control unit 30 may be configured to assign a shorter travel path, at least in some sections, to an autonomous vehicle 21₁, 21₂, . . . 21ₙ in the fleet 20 having a highest priority status 51₁, 51₂, . . . 51ₙ than to other autonomous vehicles 21₁, 21₂, . . . 21ₙ in the fleet 20 having a lesser priority status 51₁, 51₂, . . . 51ₙ. The shorter path may comprise, for example, a shorter road or shorter lane. The shorter travel path may therefore relate to a longer distance, such as in the selection of a shorter connecting road, or to a shorter distance, such as in the selection of a lane or line of travel shortening the distance.

In accordance with embodiments, alternatively or additionally, the central control unit 30 may be configured to assign a travel path that is designated for faster travel, at least in some sections, to an autonomous vehicle 21₁, 21₂, . . . 21ₙ in the fleet 20 having a first priority status 51₁, 51₂, . . . 51ₙ than to other autonomous vehicles 21₁, 21₂, . . . 21ₙ in the fleet 20 having a lesser priority status 51₁, 51₂, . . . 51ₙ. The faster travel path may comprise, for example, a faster road or a faster lane. The “design” for faster travel may have been granted by a natural or technical condition of the road, for instance, a better or wider road or road surface, or may also have been created by cultural requirements by establishment of a lane as an overtaking lane and such like.

In accordance with embodiments, alternatively or additionally, the central control unit 30 may be configured to assign a higher speed, to assign an overtaking lane, or to assign a superordinate rank at a junction, at least in some sections, to an autonomous vehicle 21₁, 21₂, . . . 21ₙ in the fleet 20 having a first priority status 51₁, 51₂, . . . 51ₙ , and/or to assign a lower speed or a stop, to assign a slower lane (i.e., an already congested lane), or to assign a subordinate rank at a junction, at least in some sections, other autonomous vehicles 21₁, 21₂, . . . 21ₙ in the fleet 20 having a lesser priority status 51₁, 51₂, . . . 51ₙ.

The terms “coupled,” “attached,” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SYMBOLS

10 Vehicle fleet control system

20 Vehicle fleet

21, 22, 23 Autonomous vehicles

30 Central control unit

40 Travel Route

41 Point of Departure

42 Point of Destination

50 Priority Protocol

51 First Priority Status

52 Second Priority Status

What is claimed is:

1. A vehicle fleet control system, comprising:
a vehicle fleet having at least two autonomous vehicles; and
a control unit configured to control the autonomous vehicles by assigning a priority status to each autonomous vehicle in the fleet, and calculating a travel route for each autonomous vehicle in the fleet on a basis of the assigned priority status, the travel route including a point of departure and a point of destination,
wherein, for autonomous vehicles having a same point of departure and a same point of destination, the control unit is configured to control the autonomous vehicle in the fleet having a greatest priority status down a calculated route that facilitates reaching the point of destination more rapidly than other autonomous vehicles in the fleet.

2. The vehicle fleet control system of claim 1, wherein the control unit is configured to calculate a travel route for each autonomous vehicle in the fleet in response to a travel route request.

3. The vehicle fleet control system of claim 1, wherein the priority status is assigned on a basis of a financial transaction.

4. The vehicle fleet control system of claim 3, wherein the financial transaction represents a purchase of a temporally limited service.

5. The vehicle fleet control system of claim 3, wherein the financial transaction represents a purchase of an hourly, daily, weekly, monthly, or annual ticket.

6. The vehicle fleet control system of claim 1, wherein the priority status comprises a first priority status assigned on the basis of a first financial transaction and a second priority status on the basis of a second financial transaction.

7. The vehicle fleet control system of claim 6, wherein the first financial transaction is greater in value than the second financial transaction.

8. The vehicle fleet control system of claim 6, wherein the first financial transaction and the second financial transaction respectively represents a purchase of a temporally limited service.

9. The vehicle fleet control system of claim 6, wherein the financial transaction represents a purchase of an hourly, daily, weekly, monthly, or annual ticket.

10. The vehicle fleet control system of claim 1, wherein, for an autonomous vehicle in the fleet having an assigned first priority status, the control unit is configured to calculate the travel route having a shorter travel path, at least in some sections.

11. The vehicle fleet control system of claim 1, wherein:
for an autonomous vehicle in the fleet having an assigned first priority status, the control unit is configured to calculate the travel route that is designed for faster travel, at least in some sections; and
for an autonomous vehicle in the fleet having an assigned second priority status, the control unit is configured to calculate the travel route that is designed for slower travel, at least in some sections.

12. The vehicle fleet control system of claim 1, wherein:
an autonomous vehicle in the fleet having an assigned first priority status is controlled by the control unit at a higher speed than autonomous vehicles in the fleet having an assigned second priority status; and
an autonomous vehicle in the fleet having an assigned second priority status is controlled by the control unit at a lower speed than autonomous vehicles in the fleet having an assigned first priority status.

13. The vehicle fleet control system of claim 1, wherein, for an autonomous vehicle in the fleet having an assigned first priority status, the control unit is configured to assign an overtaking lane thereto.

14. The vehicle fleet control system of claim 1, wherein:
for an autonomous vehicle in the fleet having an assigned first priority status, the control unit is configured to assign a superordinate rank at a junction, at least in some sections; and
for an autonomous vehicle in the fleet having an assigned second priority status, the control unit is configured to assign a subordinate rank at a junction, at least in some sections.

15. A vehicle fleet control system, comprising:
a vehicle fleet having a plurality of autonomous vehicles; and
a control unit configured to control the autonomous vehicles by assigning a priority status to each autonomous vehicle in the fleet, and calculating a travel route for each autonomous vehicle in the fleet on a basis of the assigned priority status, the travel route including a point of departure and a point of destination,
wherein, for autonomous vehicles having a same point of departure and a same point of destination, the control unit is configured to control the autonomous vehicle in the fleet having a greatest priority status down a calculated route that facilitates reaching the point of destination more rapidly than other autonomous vehicles in the fleet.

16. The vehicle fleet control system of claim 15, wherein the priority status is assigned on a basis of a financial transaction.

17. The vehicle fleet control system of claim 15, wherein the priority status comprises a first priority status assigned on the basis of a first financial transaction and a second priority status on the basis of a second financial transaction, the first financial transaction being greater in value than the second financial transaction.

18. The vehicle fleet control system of claim 17, wherein, for an autonomous vehicle in the fleet having an assigned first priority status:
the control unit is configured to calculate the travel route that is designed for faster travel, at least in some sections;
is controlled by the control unit at a higher speed than autonomous vehicles in the fleet having an assigned second priority status; and
the control unit is configured to assign a superordinate rank at a junction, at least in some sections.

19. The vehicle fleet control system of claim 17, wherein, for an autonomous vehicle in the fleet having an assigned second priority status:
the control unit is configured to calculate the travel route that is designed for slower travel, at least in some sections;
an autonomous vehicle in the fleet having an assigned second priority status is controlled by the control unit at a lower speed than autonomous vehicles in the fleet having an assigned first priority status; and
the control unit is configured to assign a subordinate rank at a junction, at least in some sections.
